(19) United States
(12) Patent Application Publication
(10) Pub. No.: US 2010/0202737 A1
(43) Pub. Date: Aug. 12, 2010

(54) Surface Egress and/or Ingress Housing

(76) Inventor: Paul Vincent Saunders, Isle of Wight (GB)

Correspondence Address: QUARLES & BRADY LLP, 411 E. WISCONSIN AVENUE, SUITE 2040, MILWAUKEE, WI, 53202-4497, US

(21) Appl. No.: 12/596,387

(22) PCT Filed: Apr. 16, 2008
(86) PCT No.: PCT/GB08/01334

§ 371 Date: Apr. 14, 2010

(30) Foreign Application Priority Data
Apr. 19, 2007 (GB) 0707621.9

(51) Int. Cl. G02B 6/38

(52) U.S. Cl. 385/69

(57) ABSTRACT

A surface egress and/or ingress housing is provided for an elongate flexible member. A front opening in a front surface of the housing can receive a connector for the elongate flexible member. A base of the housing can be at least partially received under an embedding layer for mounting the housing on the surface. An internal cavity in the housing can communicate with the front opening and with a rear opening in the base. The rear opening and the cavity can be wider than the elongate flexible member to facilitate mounting of the housing.

### BACKGROUND

The present invention relates to surface egress and/or ingress housing for use with a cable, for example a fibre optic cable.

WO 2005/103786 describes a waveguide assembly that includes a waveguide on a substrate, a waveguide housing and an embedding layer embedding at least part of the waveguide housing. The waveguide housing comprises a waveguide channel for guiding a waveguide from the substrate through the embedding layer. The waveguide can be a fibre optic cable. The waveguide assembly is a complex and expensive and requires very accurate placement of the connector to avoid damaging the waveguide.

### SUMMARY

An aspect of the invention provides a surface egress and/or ingress housing for an elongate flexible member. The housing includes a body having a first surface, with a first opening for receiving a connector for the elongate flexible member, and a base to be at least partially received under an embedding layer for mounting the housing on the surface. The base includes a second opening that is wider than the elongate flexible member and the body further includes an internal cavity in communication with the first opening and the second opening and being wider than the elongate flexible member.

Providing a second opening and an internal cavity that are wider than the elongate flexible member can enable lateral movement of the housing during the locating of the housing on the surface, and can thereby facilitate the locating and mounting of the housing on the surface.

An embodiment of the invention can provide a structure with at least one such housing, a substrate having a surface on which the housing is mounted, a connector for an elongate flexible member mounted to the housing and an elongate flexible member that is attached to the connector and passes through the housing and into the substrate.

An embodiment of the invention can provide a method of supporting an end of an elongate member that is embedded in a substrate. The method can include passing the elongate flexible member though the first and second openings of a such a housing, locating the housing on the surface of the substrate, mounting a connector attached to the end of the elongate flexible member at the first opening of the housing, and at least partially embedding the base of the housing under an embedding layer. By providing a second opening wider than the elongate flexible member with an internal cavity wider than the elongate flexible member lateral movement of the housing during the locating of the housing on the surface of the substrate and during the embedding of the base of the housing is possible, facilitate the locating and mounting of the housing on the surface.

Although various aspects of the invention are set out in the accompanying independent claims, other aspects of the invention include any combination of features from the described embodiments and/or the accompanying dependent claims with the features of the independent claims, and not solely the combinations explicitly set out in the accompanying claims.

### BRIEF DESCRIPTION OF THE DRAWINGS

Embodiments of the invention are described, by way of example only, with reference to the accompanying drawings.

FIG. 1 is schematic perspective view of a front of an example of a housing;

FIG. 2 is a schematic perspective view of a rear of the housing of FIG. 1;

FIG. 3 is a schematic front view of an assembly comprising an example of the housing of FIG. 1 mounted on a surface of a substrate;

FIG. 4 is a schematic cross-section of the assembly of FIG. 3;

FIG. 5 is a schematic rear view of the assembly of FIG. 3;

FIG. 6 is a schematic cross-section of an assembly comprising another example of a housing;

FIG. 7 is a schematic representation of an example of a structure that includes two housings.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the claimed invention.

### DETAILED DESCRIPTION

Embodiments of the invention are described that enable the supporting of an end of an elongate flexible member that is embedded in a substrate. The substrate can, for example, be a composite material in which an elongate flexible member such as an optical fibre is located to performing monitoring functions, for example for monitoring temperature and/or strain within the composite material. The housing can thus provide a support for the end of the elongate flexible member and a connector for the elongate flexible member.

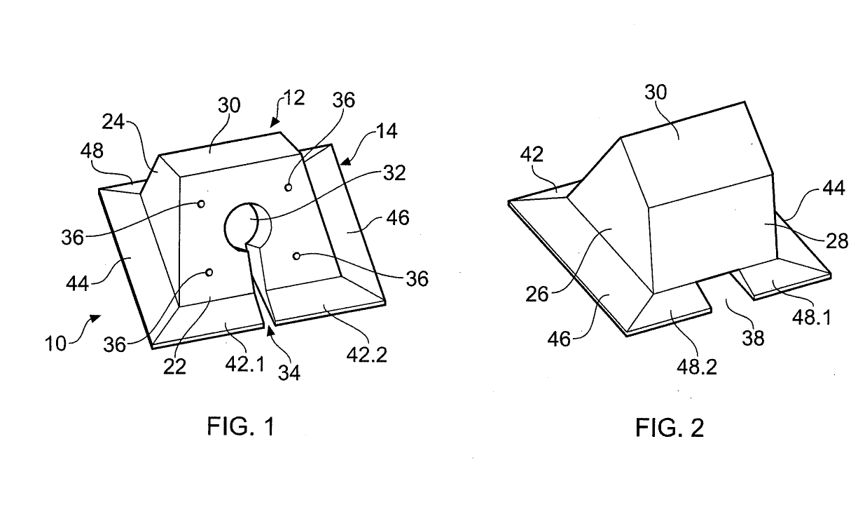

FIG. 1 is perspective view of a front of an example of a housing 10 that can support the end of an elongate flexible member (e.g., an optical fibre or other waveguide) that emerges from and/or enters into a substrate. FIG. 2 is a perspective view of the rear of the housing of FIG. 1.

As shown in FIGS. 1 and 2, the housing 10 comprises a body 12 and a base 14. In this example the body 12 and the base 14 are integral to each other.

The body 12 in the example of a housing 10 shown in FIGS. 1 and 2 has a first face 22 that forms a front surface. A second face 24 is adjacent to the first face and forms a first side surface. A third face 26 is adjacent to the other side of the first face 22 and forms a second side surface. A fourth face 28 is adjacent to the second and third faces 24 and 26 and forms a rear surface. A fifth face 30 forms a top surface and is adjacent to each of the first, second, third and fourth faces.

In the example shown in FIGS. 1 and 2, the base 14 comprises a flange-like member that extends away from the body. The base can have a substantially flat lower surface for mounting on the surface of substrate, but it could also be provided with a profile, for example to facilitate locating and/or mounting the housing on the surface of the substrate. In the illustrated example, the base 14 includes a first portion 42 adjacent to the first face 22 of the body, a second portion 44 adjacent to the second face 24 of the body, a third portion 46 adjacent to the third face 26 of the body, and a fourth portion 48 adjacent the fourth face 28 of the body. In the particular example illustrated in FIGS. 1 and 2, it will be noted that the first portion 42 of the base is split into two sub-portions 42.1 and 42.2 by a slot 34, the purpose of which is described later. Similarly, it will be noted that the fourth portion 44 of the base is split into two sub-portions 48.1 and 48.2 by an opening 38, the function of which is described later.

The front face 22 of the body 12 is provided with a first (or front) opening 32. This opening 32 in the first surface 22 leads to an internal cavity in the body and is configured to receive a connector for the elongate flexible member as will be explained later. In the example of a housing 10 illustrated in FIGS. 1 and 2, the front face 22 is formed with formations (e.g., threaded holes) for receiving fixings (e.g., screws) for mounting the connector on the housing as will be explained later. The slot 34 extends from a lower edge of the opening 32 to the bottom of the base 14 for receiving the flexible member when the housing is being installed as will be described in more detail later.

The rear of the base 14 of the housing 10 is provided with a second (or rear) opening 38 that is configured to allow the elongate flexible member to pass from the connector via the internal cavity in the body and into the substrate. As will be described later, the second opening and the cavity are configured to have a width substantially greater than the width of the elongate flexible member to enable lateral movement of the housing during assembly without trapping or damaging the elongate flexible member. This will become clear in the following description.

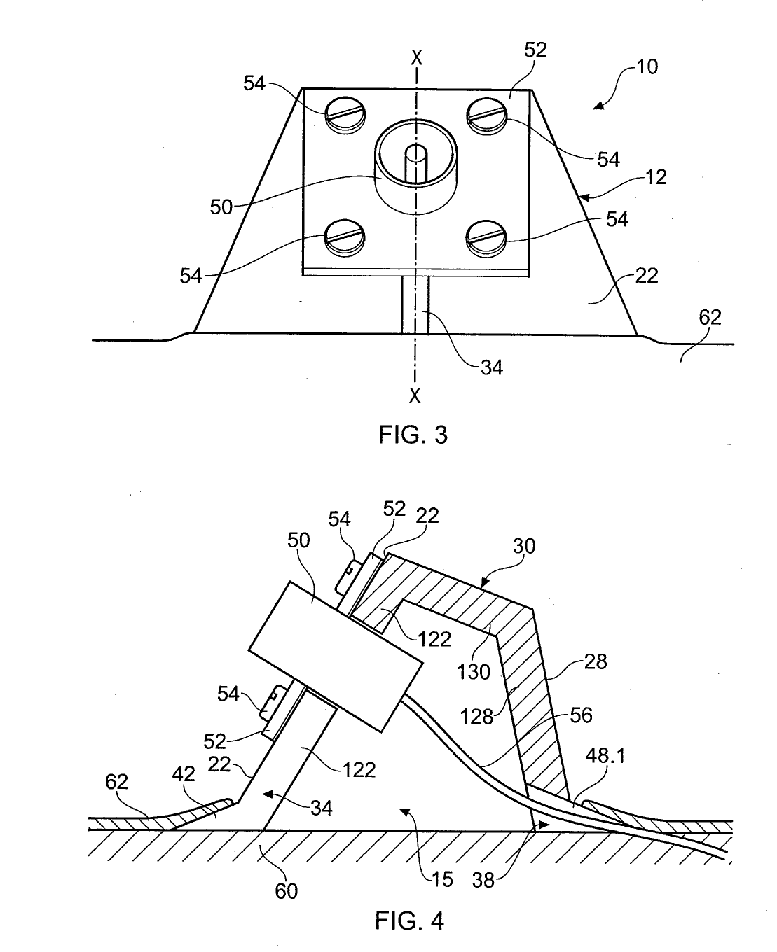

FIG. 3 is a schematic front view of a housing of FIG. 4 mounted on a substrate and with a connector 50 for the elongate flexible member mounted on the front face 22 of the housing 10. In the present example, the elongate flexible member is an optical fibre and the connector is a standard optical fibre connector. The opening 32 can be configured (e.g. by being machined) to a shape that will accept any shape of connector.

In the example shown in FIG. 3, the optical connector 50 is screwed to the front face 22 of the body 12 using screws 54 that can be received in the threaded holes 36 in the front face 22 of the body 12. The screws pass through holes (not shown) in a flange 52 that forms part of the connector 50. In the configuration shown in FIG. 3, the flange 54 overlies part of the slot 34. In another configuration, it might cover the whole or a smaller part of the slot 34.

As will be described later, in other embodiments the connector could take another form and could be mounted on the housing in another way. For example, in one example embodiment, the connector may or may not have a flange and can be bonded to the housing.

FIG. 3 also illustrates that an embedding layer 62 overlies the flange-like base 14 of the housing 10 to mount the housing on the substrate surface.

FIG. 4 is a cross-section taken along the line X-X in FIG. 3, which extends generally vertically through the middle of the front face 22 of the housing, but passes around the body of the connector 50.

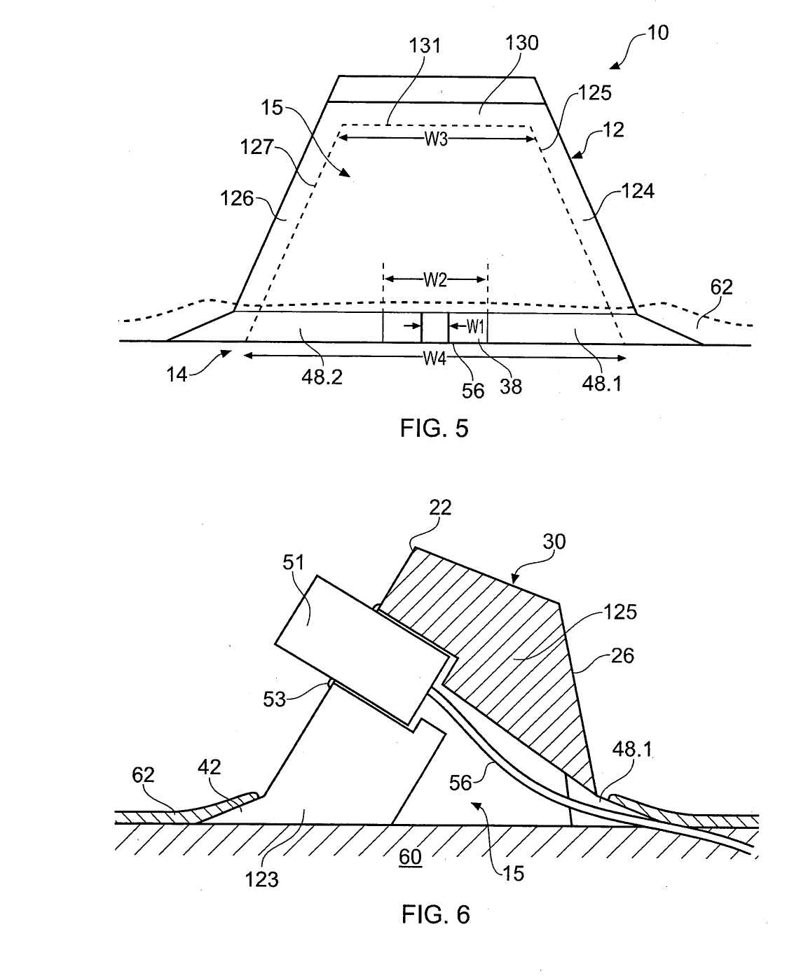

FIG. 4 shows that the body of the housing is formed from walls that define the faces of the housing. A front wall 122 defines the front surface 22. The cross-section of FIG. 4 passes through the slot 34 in the front wall 122 below the connector 50, which is the reason that the front wall is shown in cross-section above the connector 50 and the front wall and the first (the front) portion 42 of the base 14 are not shown in cross-section below the connector 50. An upper wall 130 defines the fifth surface 30. A rear wall 128 defines the fourth surface 28. Similarly first and second side walls (not shown in FIG. 4, but see FIG. 5 later) define the second and third surfaces 24 and 26. The cross-section of FIG. 4 also passes through the second opening 38 formed in the fourth portion 48 of the base 14, which is why the bottom of the rear wall 128 and the fourth (rear) portion 48 of the base 14 are not shown in cross-section.

FIG. 4 also shows how the walls of the body portion form a cavity 15 that is open to the bottom of the housing and extends across the width of the housing between the side walls. FIG. 4 illustrates that the elongate flexible member 56 can extend from the rear of the connector 50 in a free manner and can pass though the second opening 38 under the embedding layer 62 and into the substrate 60. The width of the cavity and the rear opening 38 are such that they do not constrain or guide the elongate flexible member 56, but rather than this is greater than the width (e.g., the diameter) of the elongate flexible member, so that the lateral positioning of the housing with respect to the entry/exit point of the elongate flexible member with respect to the substrate is not critical. In use, once the housing has been mounted, the cavity 15 can be filled with resin (or another filling material) so that the elongate flexible member 56 can be held firmly in position.

FIG. 5 is a schematic rear view of the housing 10 mounted on the substrate 60. In FIG. 5, the position of the upper surface of the embedding layer 62 is illustrated by a dotted line. This is to illustrate that the width W1 of the elongate flexible member 56 is less, indeed substantially less, than the width W2 of the second opening and the width (which varies from W3 to W4) of the cavity 15 in the housing. As FIG. 5 is an external view, the inner edges 125 and 127 of the first and second side walls 124 and 126 and the inner edge 131 of the upper wall 130 are represented by dashed lines, the cavity 15 being defined within the dashed lines.

FIG. 5 also illustrates that in this example the rear portion 48 of the base 14 is slit into two parts 48.1 and 48.2 by the second opening 38. In the examples shown in the Figures, the rear opening extends up to the bottom of the rear wall 128 of the body 12. It should be appreciated that in other examples, the second opening may only extend part way up the base 14, whereby the rear portion 48 may not be completely split in two. In yet other examples, the second opening 38 may extend at least partially up the rear wall 128.

The housing can be configured to have different dimensions in different embodiments. However, in an example embodiment, for an optical fibre (including its cladding) of the order of 0.10 mm to 1 mm diameter, for example 0.5 mm diameter, W1 may be of the order of 0.5 mm to 3 mm, for example 1.5 mm, W2 may be of the order of 5 mm to 10 mm, for example 8 mm, W3 may be of the order of 15 mm to 20 mm, for example 18 mm and W4 may be of the order of 20 mm to 30 mm, for example 25 mm. The overall housing may be of the order of 15 mm to 25 mm high, for example 20 mm high and have a base dimensions of the order of 30 mm to 50 mm by 30 mm to 50 mm, for example 40 mm by 35 mm.

An example of a method of mounting the housing for supporting the end of the elongate flexible member will be explained.

The elongate flexible member 56 can be terminated in advance with the connector 50 before the elongate flexible member is placed in the substrate 60 to facilitate the attachment of the connector and also the handling of the optical fibre when this is placed in the substrate. However, as an alternative, the elongate flexible member 56 could be terminated with the connector 50 after the elongate flexible member is placed in the substrate 60.

The housing 10 can be offered up to the exposed portion of the elongate flexible member 56 and the elongate flexible member can be slid though the slot 34 until the connector lines up with the first opening 34. The connector can then be secured to the front face 22 of the housing 10. In the present example this is done using screws that pass though holes (not shown) in the flange 52 of the optical connector and into threaded holes 36 in the front face 22 of the housing 10. As mentioned above, in other examples, other fixings methods can be used. For example, rather than providing threaded holes 36 in the housing 10, self tapping screws could be used. Alternatively, or in addition, other fastening or fixing arrangements could be used. For example, in an embodiment the connector could be bonded or glued in place.

The elongate flexible member that leaves the rear of the connector 50 can pass freely and without hindrance through the cavity 15 in the housing 10 and through the rear (the second) opening 38 into the substrate.

With the housing located on the surface of the substrate, one or more embedding layers 62 can then be added to the surface of the substrate 60 and can be arranged to cover at least part of the base 14 to embed the base of the housing 10. Due to the wide internal cavity 15 and the wide rear opening 38, the exact position of the housing is not critical, and lateral (side to side) and longitudinal (front to back can back to front) movement of the housing with respect to the entry and/or exit point of the elongate flexible member can occur during the mounting process.

The housing can then be secured in place by curing, hardening or otherwise fixing the embedding layers. At the same time or subsequently, the internal cavity can optionally be filled with, for example, a resin that can then be cured to fix the elongate flexible member in place.

FIG. 6 illustrates a variation on the housing illustrated in FIG. 4. In the example shown in FIG. 6, rather than separate walls defining the front and rear surfaces, it can be seen that the housing is configured more as a block with solid portions 123 and 125 and with a smaller cavity 115. The cavity 115 may be narrower than the cavity 15 illustrated in FIG. 5 but is still configured to have a width substantially greater than the width of the elongate flexible member and generally defines a 3-dimensional cavity in the same manner as in the example of FIG. 4 in order to provide the flexibility in the positioning and mounting of the housing 10.

FIG. 6 further illustrates an example embodiment where a different form of connector 51 that does not have a flange is used. In this particular example, the connector 51 is secured in place using glue or other bonding material 53. It will be appreciated that the connector 51 of FIG. 6 could also be used with the housing of FIG. 1-5, and that a connector 50 as shown in FIGS. 1-5 could be used with the housing of FIG. 6. In addition, it will be appreciated that the housing 50 shown in FIGS. 1-5 could be bonded or glued in place rather than or in addition to being screwed in place. Indeed, any suitable fastening or mounting arrangement could be used according to the type of connector 50/51 that is employed, it being appreciated that the connectors 50 and 51 are merely representations of possible connectors.

In an example embodiment, the width of the second (the rear) opening can be greater than the height of the second opening. In an example embodiment the width of the second (the rear) opening is substantially greater than the width (e.g., the diameter) of the elongate flexible member, for example at least 1.5 (e.g., at least a plurality of times) the width of the elongate flexible member. In an example embodiment the width of the internal cavity is at least as wide or wider than the rear opening, that is substantially greater than the width (e.g., the diameter) of the elongate flexible member, for example at least 1.5 (e.g., at least at least a multiple of) the width of the elongate flexible member.

In an example embodiment, the body of the housing can be integral with the base for ease of manufacture, strength and cost. The housing can be manufactured of any suitable materials. Examples of suitable materials are a plastics material, a metal, and a ceramic material, a composite material, or any suitable combination of these and/or or other materials.

The housing can be formed in any suitable manner, for example by moulding (e.g., injection moulding of a plastics material), stamping from a sheet material (e.g., by stamping a sheet of metal), or by machining (e.g., from a block of material), or any suitable combination of these and/or or other methods.

Although in the described example, the elongate flexible member is a waveguide, more specifically a fibre optic cable, the housing could also be used to mount an electrical cable or a fluid hose or other flexible conduit, or indeed any other elongate flexible member.

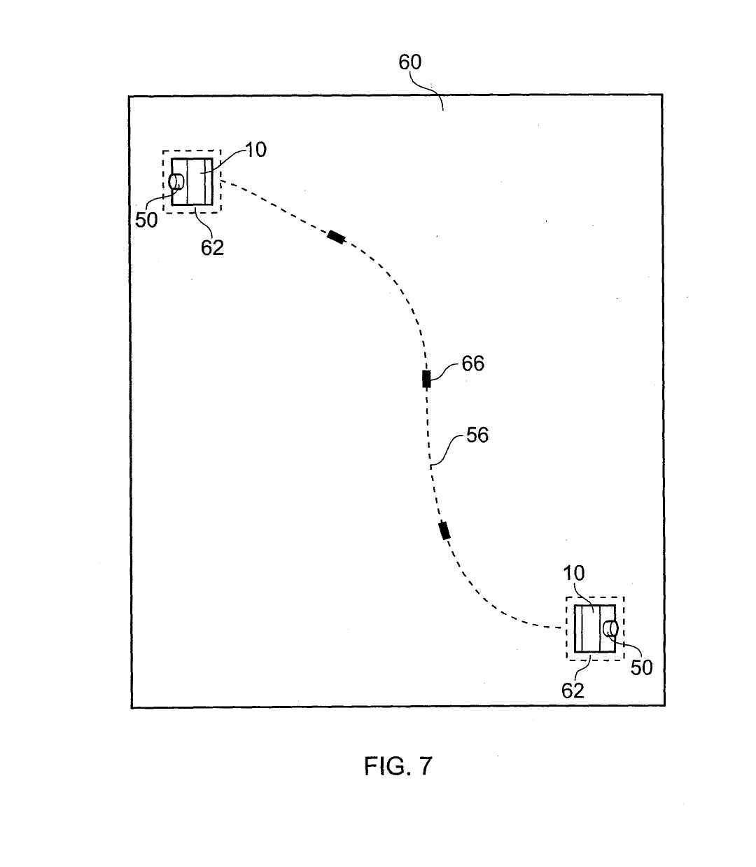

FIG. 7 illustrates an example of a structure that includes two housings 10 as described above, a substrate 60 having a surface on which the housings is mounted and through which an optical fibre 56 extends. The optical fibre can be configured, for example, to provide strain gauges 66, for example as described in the applicant's European patent application 0725087.5, filed 24 Jan. 2007. The housings can be mounted at each end of the optical fibre using one or more embedding layers that extend at least partially over the base 14 of the housing 10. A respective optical fibre connector 50 is attached to the optical fibre in each of the housings 10. This means that if a fault develops along the fibre, or in one of the housings, access can still be made to the strain gauges 66 by choosing an appropriate connector 50. In another example, a connector 50 and/or housing 10 may be provided at one end only of the optical fibre. As described above, in the final assembly, the cavity in the housing can be filled with resin or another filling material. The substrate can, for example, be formed of a composite material, for example a composite material laid down in layers. The substrate can, for example, form part of or the whole of an aircraft structure or other aerospace structure.

Accordingly, there has been described a surface egress and/or ingress housing for an elongate flexible member. A front opening in a front surface of the housing can receive a connector for the elongate flexible member. A base of the housing can be at least partially received under an embedding layer for mounting the housing on the surface. An internal cavity in the housing can communicate with the front opening and with a rear opening in the base. The rear opening and the cavity can be wider than the elongate flexible member to facilitate mounting of the housing.

There has also been described a structure that includes at least one housing as described herein, a substrate having a surface on which the housing is mounted, a connector for an elongate flexible member mounted to the housing and an elongate flexible member that is attached to the connector and passes through the housing and into the substrate.

A method of supporting an end of an elongate member that is embedded in a substrate includes passing the elongate flexible member though the first and second openings of a housing as described herein, locating the housing on the surface of the substrate, mounting a connector attached to the end of the elongate flexible member at the first opening, and at least partially embedding the base of the housing under an embedding layer, wherein the second opening and the internal cavity are wider than the elongate flexible member to enable at least lateral movement of the housing during the locating of the housing on the surface of the substrate and during the embedding of the base of the housing.

Although the embodiments above have been described in considerable detail, numerous variations and modifications will become apparent to those skilled in the art once the above disclosure is fully appreciated. It is intended that the following claims be interpreted to embrace all such variations and modifications as well as their equivalents.

1-27. (canceled)

28. A surface egress and/or ingress housing for an elongate flexible member, the housing comprising a body having a first surface with a first opening for receiving a connector for the elongate flexible member, and a base to be at least partially received under an embedding layer for mounting the housing on the surface, the base including a second opening that is wider than the elongate flexible member, the body further comprising an internal cavity in communication with the first opening and the second opening and being wider than the elongate flexible member, wherein the body is integral with the base and the first surface is formed with a slit that extends from a portion of the base adjacent the first surface to the first opening, the slit being operable to receive the elongate flexible member during mounting of the housing on the surface.

29. The housing of claim 28, wherein the width of the second opening is greater than the height of the second opening.

30. The housing of claim 28, wherein the width of the second opening is at least a multiple of the width of the elongate flexible member.

31. The housing of claim 28, wherein the internal cavity is wider than the second opening.

32. The housing of claim 28, wherein the body comprises a first wall forming the first surface that is adjacent to a second wall forming a second surface and a third wall forming a third surface, a fourth wall forming a fourth surface being adjacent to the second and third walls and a fifth wall that forms a fifth surface being adjacent each of the first, second, third and fourth walls.

33. The housing of claim 32, wherein the base comprises a first portion adjacent the first surface, a second portion adjacent the second surface, a third portion adjacent the third surface, and a fourth portion adjacent the fourth surface.

34. The housing of claim 28, wherein the first surface comprises at least one formation for mounting a connector for the elongate flexible member.

35. The housing of claim 34, wherein at least one formation comprises a threaded hole for receiving a screw.

36. The housing of claim 28, wherein the base forms a flange that extends at least partially around the body.

37. The housing of claim 28, comprising a plastics material.

38. The housing of claim 28, comprising metal.

39. The housing of claim 28, comprising a ceramic material.

40. The housing of claim 28, formed by molding.

41. The housing of claim 28, formed by stamping.

42. The housing of claim 28, formed by machining.

43. The housing of claim 28, wherein the elongate flexible member is a waveguide.

44. The housing of claim 28, wherein the elongate flexible member is a fiber optic cable.

45. A structure comprising at least one housing according to claim 28, a substrate having a surface on which the housing is mounted, a connector for an elongate flexible member mounted to the housing and an elongate flexible member that is attached to the connector and passes through the housing and into the substrate.

46. The structure of claim 45, wherein the housing is mounted on the surface of the substrate by means of an embedding layer that extends at least partially over the base of the housing.

47. The structure of claim 45, wherein the cavity in the housing is filled with resin.

48. The structure of claim 45, wherein the structure comprises at least two housings according to claim 28, and wherein a first one of the housings is at a first end of the elongate flexible member and a second one of the housings is at a second end of the elongate flexible member.

49. The structure of claim 45, wherein the elongate flexible member is a fiber optic cable.

50. The structure of claim 45, wherein the substrate is a composite material.

51. The structure of claim 45, wherein the substrate forms part of an aircraft structure.

52. A method of supporting an end of an elongate member that is embedded in a substrate using a housing according to claim 28, the method comprising: receiving the elongate flexible member in the slit of the housing, passing the elongate flexible member through the first and second openings of the housing, locating the housing on the surface of the substrate, mounting a connector attached to the end of the elongate flexible member at the first opening, and at least partially embedding the base of the housing under an embedding layer, wherein the second opening and the internal cavity are wider than the elongate flexible member to enable at least lateral movement of the housing during the locating of the housing on the surface of the substrate and during the embedding of the base of the housing.
